(19) United States
(12) Patent Application Publication
(10) Pub. No.: US 2003/0001503 A1
(43) Pub. Date: Jan. 2, 2003

(54) Discharge lamp of the short arc type

(75) Inventors: Yoichiro Higashimoto, Himeji-shi (JP); Takeo Matushima, Himeji-shi (JP); Kyosuke Fujina, Shiso-gun (JP)

Correspondence Address: NIXON PEABODY, LLP, 8180 GREENSBORO DRIVE, SUITE 800, MCLEAN, VA, 22102, US

(73) Assignee: Ushiodenki Kabushiki Kaisha, Tokyo (JP)

(21) Appl. No.: 10/170,631

(22) Filed: Jun. 14, 2002

(30) Foreign Application Priority Data
Jun. 14, 2001 (JP) 2001-179674

(51) Int. Cl. H01J 17/04

(52) U.S. Cl. 313/631

(57) ABSTRACT

A discharge lamp of the short arc type having sufficiently high radiance without being accompanied by deformation and wear of the anode in use. In the discharge lamp of the short arc type having a discharge vessel, there are a cathode having a tip area in the shape of a truncated cone and an opposite anode having a tip area in the shape of a truncated cone. The discharge vessel is filled with xenon gas, and the discharge lamp is operated in a configuration in which a center axis of the cathode and a center axis of the anode are each positioned horizontally. The nominal wattage of the discharge lamp is 0.5 kW to 5 kW, and the filling pressure of the xenon gas is greater than or equal to 1.5 MPa. The center axis of the cathode is displaced below the center axis of the anode, and the amount of displacement of the cathode is 10% to 15% of the distance between the cathode and the anode in the axial direction. Further, in the discharge lamp of the present invention, least one end of the discharge vessel is provided with a base having a means for controlling the operating position.

### BACKGROUND OF THE INVENTION

1. Field of the Invention

The invention relates to a discharge lamp of the short arc type. More particularly, the invention relates to a discharge lamp of the short arc type used as a light source in a projection device, wherein light modulation elements are irradiated with light from the discharge lamp and the reflection the light is used to project images.

2. Description of Related Art

Currently a discharge lamp of the short arc type is commonly used as a light source of a projection device, such as a projector or the like, since it emits light having wide wavelength range, and since the radiant light has spectra which are similar to sunlight. In a discharge lamp of the short arc type having a discharge vessel of quartz glass, there are a cathode and an opposite anode. Moreover, the discharge vessel is filled with xenon gas. In the case when a discharge lamp of the short arc type is used as a light source in a projection device in a theater with a dark environment, the lamp needs to have sufficient radiance to project a screen illuminance.

However, recently is has become more and more frequent to apply a discharge lamp in a projector at event sites with bright ambiance lighting, especially in the open, and to project images during the daytime. In a conventional discharge lamp of the short arc type used in a bright environment, sufficient screen illuminance cannot be obtained, since the lamp inherently does not have high radiance. Therefore, images cannot be projected effectively for viewers to see. Accordingly, the radiance is increased by reducing the distance between the electrodes and the arc formed between the converging cathode and anode, and the focusing capacity of the lamp is increased by using a reflector. In this case the distance between the electrodes must be, for example, less than or equal to 7 mm.

However, since the tip area of the anode produces an arc radiance spot having the highest temperature in the arc when the distance between the electrodes is reduced, the thermal effect exerted by the arc on the anode becomes greater. Consequently, this causes a temperature increase of the anode.

Furthermore, in a discharge lamp of the short arc type installed in a projection device, the anode temperature tends to become high as the anode is shifted into the temperature state to reach a thermal stability temperature.

The reason for this is as follows:

In order to obtain a sufficiently high radiance in a light source in projection device, the nominal wattage of a discharge lamp of the short arc type must be increased. However, since there is a limitation with respect to the capacity of the power source and the required insulation property of the lamp, it is difficult to increase the voltage value applied to the lamp significantly. It is therefore required that the current value be raised. Consequently, the nominal wattage of the discharge lamp is increased. For example, the lamp must be operated with a high current of greater than or equal to 70 A.

On the other hand, with respect to reducing the size of the light source device or with respect to the optical construction of a discharge lamp of the short arc type operating in a horizontal position, the lamp is normally installed in a light source device wherein the optical axis of the reflector which runs in the horizontal direction, and the direction of the arc in the discharge lamp also runs in the horizontal direction.

To stabilize the arc formed between the cathode and the anode, the tip surface of the anode is made flat. In this way the base region of the arc becomes essentially the same size as the diameter of the tip surface of the anode and is formed such that it covers the entire area of the tip surface of the anode. The position of the arc is maintained securely at a certain point.

On the other hand, it is known that, due to the influence of convection of the added gas within the discharge vessel of a horizontally-operated discharge lamp of the short arc type, a phenomenon in which the arc floats to the top occurs (hereinafter called the “arc floating phenomenon”).

As described above, in a discharge lamp of the short arc type, the distance between the electrodes is extremely small so that the discharge lamp can acquire sufficient radiance, and that the anode temperature is the temperature near the thermal stability temperature. As shown in FIG. 6, when the arc floating phenomenon occurs, an arc A formed between the cathode 61 and the cathode 62 is concentrated on the edge area E on the tip surface of the anode 62, or the area in which the base region of the arc A covering the tip surface of the anode 62 becomes narrower. As a result the anode 62 is shifted into the temperature state that is locally excessive, and hence the anode 62 is deformed or worn within an extremely short time and becomes usable.

### SUMMARY OF THE INVENTION

It is an object of the present invention to eliminate the above described disadvantages in the prior art.

It is another object of the invention to provide a discharge lamp of the short arc type having sufficiently high radiance without being accompanied by deformation and wear of the anode during use.

According to an embodiment of a discharge lamp of the short arc type of the present invention, in a discharge vessel filled with xenon gas, there are a cathode with a tip area in the shape of a truncated cone and an opposite anode with a tip area in the shape of a truncated cone. Moreover, the center axis of this cathode and the center axis of this anode are each positioned horizontally and are each offset from each other. More specifically, the cathode is in the state in which its center axis is located underneath the center axis of the anode, and that the amount of displacement of the cathode is 10% to 15% of the distance between the cathode and the anode in the axial direction. Further, the nominal wattage of the discharge charge lamp of the present invention is 0.5 kW to 5 kW, and the filling pressure of the xenon gas is greater than or equal to 1.5 MPa.

In the discharge lamp of the short arc type of the invention, at least one end of the discharge vessel is provided with a base having a means for controlling the operating position of the discharge lamp.

By means of the above described features of the discharge lamp of the short arc type of the present invention, light with high radiance is emitted and the lamp is operated horizontally wherein the arc is reliably and stably held in the middle area of the tip surface of the anode. Therefore, the anode is prevented from being locally deformed or worn, and a stable operating characteristic can be obtained over a long period of time.

The invention is further described below using several embodiments shown in the drawings.

### BRIEF DESCRIPTION OF THE DRAWINGS

FIG. 1 shows a schematic of the arrangement of an example of a discharge lamp of the short arc type of the present invention;

FIG. 2 shows a schematic of the positional relationship of the cathode and the anode in a discharge lamp of the short arc type shown in FIG. 1;

FIG. 3 shows a front view of the arrangement of the base in the discharge lamp of the short arc type as shown in FIG. 1;

FIG. 4 shows a schematic of the arrangement of an example of a lamp holder by which the discharge lamp of the short arc type of the in the present invention is held;

FIG. 5 shows a schematic cross section of the arrangement of an example of a light source device in which the discharge lamp of the short arc type of the present invention is installed; and

FIG. 6 shows a schematic of the positional relationship of the cathode and anode in a conventional discharge lamp of the short arc type.

### DETAILED DESCRIPTION OF THE INVENTION

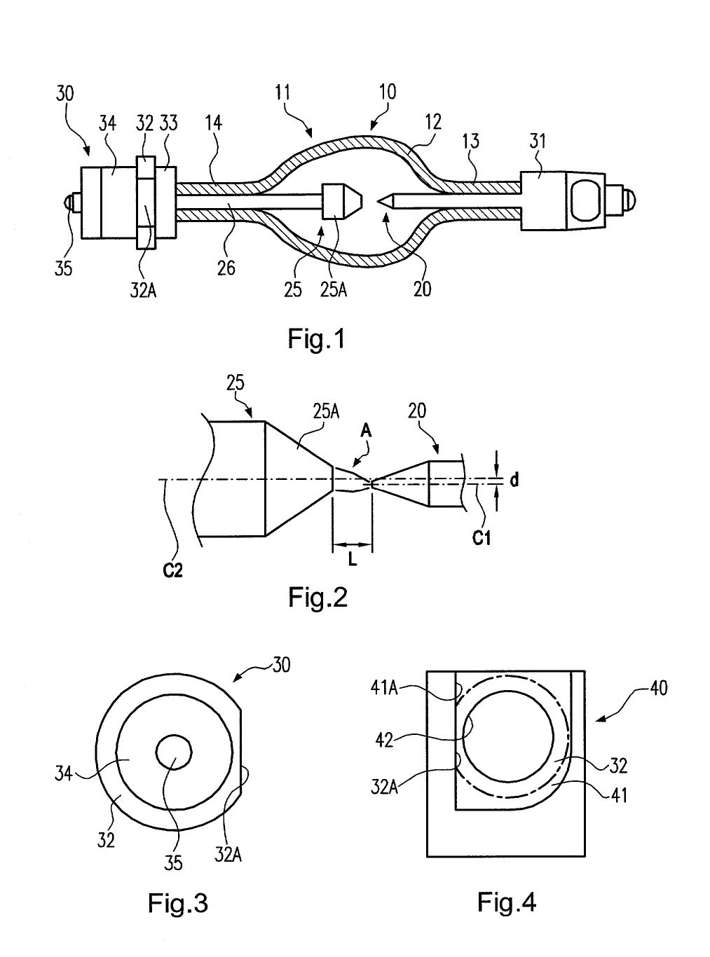

FIG. 1 shows a schematic of the arrangement of a example of a discharge lamp of the short arc type of the invention. A discharge lamp 10 of the short arc type (hereinafter also called a discharge lamp) has a discharge vessel 11 comprised, for example, of quartz glass and has an arc tube 12 and rod-shaped, hermetically sealed portions 13, 14. The portions 13, 14 border the ends of electrodes which extend outward from the two ends of the arc tube 12.

In the arc tube 12, a cathode 20, which is one of the electrodes, is located in a first part of the discharge vessel 11, as shown at the right-hand side of FIG. 1. The inside surface and the outside surface of the tube wall of the arc tube 12 are spherical. Moreover, in arc tube 12, there is a second part, as shown in the drawings in the left-hand side of the drawings, where an anode 25 is positioned. The anode 25 and the cathode 20 extend straight in the axial direction of the tube of the hermetically sealed portions 14 and 13, respectively. The arc tube 12 is, for example, spindle-shaped, and the cathode 20 and the anode 25 are opposite to one another. The cathode 20 is comprised, for example, of tungsten and is rod-shaped. Further, the cathode 20 is formed in the shape of a truncated cone such that its outside diameter decreases in the direction toward the and extends along the tube axis of the hermetically sealed portion 13. The back-end of the cathode projects into the hermetically sealed portion 13.

The anode 25 is comprised of, for example, tungsten. A tip area 25A is formed in the shape of a truncated cone such that its outside diameter decreases in the direction towards the tip. The tip area 25A is attached to the tip of an electrode-supporting portion 26 (hereinafter also called an “the anode-supporting portion” or “anode rod”) and is thereby held securely. The anode rod 26 extends into the second hermetically sealed portion 14 along the tube axis, and its back end projects into the hermetically sealed portion 14.

The distance between the cathode 25 and the anode 25 in the axial direction is, for example, 7.0 mm or less. In practice, it is desirable for the distance between the two electrodes to be in a range of 3.0 mm to 5.0 mm inclusively.

The diameter of the tip area of the anode 25 is, for example, 0.8 times to 1.2 times as great as the distance between the cathode 20 and the anode 25 in the axial direction.

In the hermetically sealed portion 13 of the discharge vessel 11, the hermetically sealed portion 13 and the area on the side of the back end of the cathode 20 are welded to one another forming a hermetically sealed area. The second hermetically sealed portion 14 of the discharge vessel 11 has the same arrangement as the hermetically sealed portion 13. That is, the hermetically sealed portion 14 and the anode rod 26 are welded to one another forming a hermetically sealed area.

The arc tube 12 is filled with xenon gas with a filling pressure of greater than or equal to 1.5 MPa, with an operating pressure of the xenon gas during operation from 6 MPa to 10 MPa. It is desirable for the filling pressure of the xenon gas in practice to be 2 MPA to 3 MPa. In the rod seal arrangement illustratively shown in the drawings, it is desirable that the filling pressure of the xenon to be greater than or equal to 2 MPa.

The discharge lamp 10 is operated in a horizontal operating position, and the center axis of the cathode 20 and the center axis of the anode 25 are each positioned and extended in the horizontal direction. As is shown in FIG. 2, the center axis C1 of cathode 20 is displaced downward relative to the center axis C2 of the anode 25.

The amount of displacement d of the cathode 20 with respect to the anode 25 is 10% to 15% of the distance L between the cathode 20 and the anode 25 in the axial direction. In this way, the arc A formed between the cathode 20 and the anode 25 can be reliably confined to the entire area of the tip surface of the anode 25. As such, the base of the arc A covers the entire area of the surface of the anode 25, even if the arc floating phenomenon occurs. Therefore, the arc A can be prevented from locally concentrating on the tip area 25A and from being shifted into the temperature exceeding thermal stability when the tip area 25A of the anode 25 is near the thermal stability temperature. Accordingly, the anode 25 is prevented from being locally damaged or deformed and a stable operating characteristic over a long period is developed.

In the discharge vessel 11, a base 31 is normally attached to the end of the hermetically sealed portion 13 and the base 30 is normally attached to the end of the hermetically sealed portion 14 with an adhesive. The base 30 in the second hermetically sealed portion 14 is installed and held in a lamp holder (not shown in the drawings) in a projection device.

As is also shown in FIG. 3, the base 30 of the second hermetically sealed portion 14 is provided with a disk-shaped collar 32 and is made tubular with respect to the anode 25. On the collar 32, a flat control surface 32A is formed as a means for controlling the operating position which extends up and down. Furthermore, on the outer end of the portion 14, the discharge lamp (on the left end in FIG. 1), an installation part 34 is formed which adjoins a base part 33 via the collar 32. On the outer end of this installation part 34, there is a feed component 35. The control surface 32A of the collar 32 of the base 30 is at a certain angle, for example, parallel, to the plane which contains both the center axis C1 of the cathode 20 and the center axis C2 of the anode 25.

By design, a lamp holder holding the discharge lamp 10 matches at least to one part of this base 30 so that the lamp is located in the desired operating position. Subsequently, the collar 32 of the base 30 can be pushed into the holder due to its shape only in the desired orientation. FIG. 4 shows one example of the arrangement of such a lamp holder.

The lamp holder 40 is block-like. Its upper middle area is provided with a concave lamp installation component 41, to which the collar 32 of the base 30 engages. At least part of the wall surface dividing the concave lamp installation part 41 is provided with a flat plane 41A by which the control surface 32A of the collar 32 of the base 30 is supposed to border or mate.

In the concave lamp installation part 41, a circular opening 42 is formed into which the installation part 34 of the base 30 is to be inserted. That is, a lamp inserted into the circular opening extends from one side to the other side in the direction perpendicular to the page of the drawings. The inside diameter of this opening 42 is matched to the outside diameter of the installation part 34 of the base 30. By means of the base 30 located in the second hermetically sealed portion 14, the discharge lamp 10 is therefore positioned in a position in which the cathode 20 is offset downward relative to the anode 25.

The discharge lamp of the short arc type 10 of the invention is operated at a nominal wattage between 0.5 kW to 5 kW.

By means of the above described discharge lamp of the short arc type 10, in the case of horizontal operation, the arc A formed between the cathode 20 and the anode 25 can be reliably held and stabilized by the entire area of the tip surface of the anode 25. Therefore, a stable operating characteristic over a long period can be obtained without the anode 25 being locally deformed or worn.

Although in a conventional discharge lamp of the short arc type, as a result of the arc floating phenomenon which inevitably occurs in the case of horizontal operation, the anode is deformed or worn in an extremely short time, with the discharge lamp of the invention, in which (1) the distance L between the electrodes is less than or equal to 7.0 mm, (2) the filling pressure of the xenon gas is greater than or equal to 1.5 MPa and (3) the nominal wattage is 0.5 kW to 5 kW, the occurrence of the defects normally caused by the arc floating phenomenon can be avoided. In this way sufficiently high radiance can be obtained. As a result, the lamp can be advantageously used, not only as a light source of a projection device of the type used in a theater with a dark environment, but also as the light source in a projection device used, for example, in the open during the day, such as in a DLP (digital light processing) cinema projector.

The discharge lamp of the short arc type 10 of the invention is combined, for example, with a reflector. Thus, a light source device is formed that is installed and used in a projection device. By means of in which part of the base 30 with respect to the anode 25 located in the second hermetically sealed portion 14 of the discharge vessel 11 is provided with a flat control surface 32A, the base 30 acts as the means for controlling the operating position of the discharge lamp. Therefore, the discharge lamp 10 can be reliably installed in a projection device in the operating position in which the cathode 20 is positioned lower relative to the anode 25.

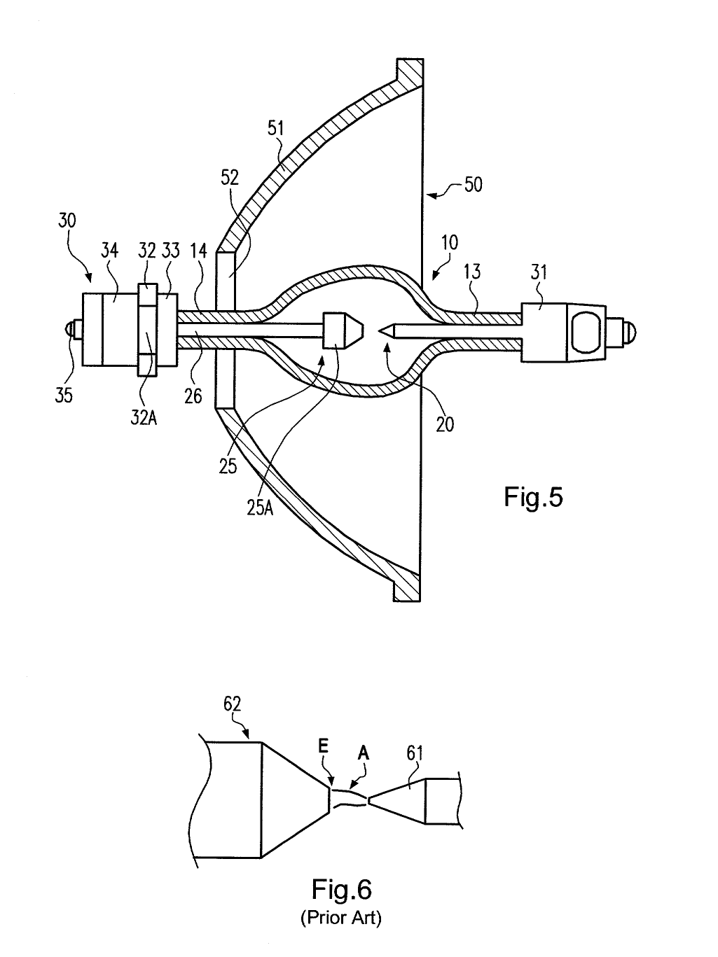

FIG. 5 is a schematic of the arrangement of a example of a light source device in which the discharge lamp of the short arc type of the invention is installed. A light source device 50 is formed by the above-described discharge lamp of the short arc type 10, in which the cathode 20 is positioned in front (on the right-hand side of the drawings) of the anode 25. The light source is installed in a concave reflector 51, which has a reflection surface of an elliptical spherical shape. Specifically, the discharge lamp of the short arc type 10 is arranged such that the second hermetically sealed portion 14 is inserted into the opening 52 on the back edge of the concave reflector 51 and extends forward thereof. The arc direction in this discharge lamp of the short arc type 10 corresponds to the horizontal optical axis of the concave reflector 51. Moreover, the arc radiance spot corresponds to the first focal point of the concave reflector 51.

In the light source device 50, the discharge lamp of the short arc type 10 inherently has high radiance. Therefore, relatively high illuminance can be obtained by the light emitted from the discharge lamp of the short arc type 10 that is focused by the concave reflector 51. Therefore, in the case of using a DLP projection device as the light source, the images can be projected onto the screen with an illuminance with which the viewer can adequately see the images.

Various details of the invention are described above. The invention is, however, not limited to the above described embodiments, but various modifications described below can be carried out for the specific arrangement of the respective parts.

(1) In an actual discharge lamp of the short arc type, it is possible to suitably change the distance between the two electrodes in the axial direction, the filling pressure of the xenon, the nominal wattage, and other arrangements. In the above described examples, the cathode is displaced downward relative to the anode. However, the cathode can also be positioned down relative to the anode, by the anode being displaced upward with respect to the cathode.

(2) The location of the base located in the second hermetically sealed portion of the discharge vessel and on which the control surface is formed as a means for controlling the operating position is not especially limited. It can be formed anywhere such that the operating position of the discharge lamp of the short arc type can be controlled in a way in which the cathode and the anode are located on top of one another. In other words, the cathode is positioned offset downward relative to the anode. The operating position of the discharge lamp of the short arc type can be controlled by the arrangement in which, for example, at least one part of the collar of the base is provided with a component for controlling the position which projects to the outside in the radial direction, or by the arrangement in which a groove is formed for controlling the position. In this case, a concave lamp installation component can be formed in the lamp holder in the projection device, wherein the installation component has a shape which is matched with the holder.

(3) The arrangement of the hermetic sealing in the discharge lamp of the short arc type is not especially limited but can be suitably changed according to conditions, such as, for example, the filling pressure of the gas the like. As an example, a hermetically sealed body for feed can be formed comprising a rod-shaped and hermetically sealed component of a material with a gradient function. An inner lead pin with a base part is attached in one piece to the hermetically sealed component and is extended from the inner end of the hermetically sealed component to the inside, and an outer lead pin with a base part is attached in one piece to the hermetically sealed component and is extended from the outer end of the hermetically sealed component to the outside. The hermetically sealed portion can be welded to the hermetically sealed body so that a hermetic seal arrangement can be formed. Furthermore, the respective inner lead forming the cathode or the anode can be electrically connected via a metal foil which is hermetically installed in the hermetically sealed portion to the outer lead pin so as forming a hermetically sealed arrangement.

Experimental examples of the discharge lamp of the short arc type as claimed in the invention are described specifically below. However, the present invention is not limited thereto.

According to the arrangement shown in FIG. 1, several discharge lamps of the short arc type 10 are produced, wherein the distance L between the cathode 20 and the anode 25 in the axial direction is 4 mm, wherein the nominal current is 75 A, the nominal voltage is 26.7 V, the nominal wattage is 2.0 kW, the filling pressure of the xenon gas is 2 MPa, and the amount d of displacement of the cathode 20 with respect to the anode 25 is changed according to Table 1 described below. These lamps are called “discharge lamp group 1”.

Here, the discharge vessel 11 is made of quartz glass. In the discharge vessel 11, the total length is 180 mm, the maximum outside diameter of the arc tube 12 is 42 mm, the maximum inside diameter of the arc tube 12 is 36 mm, the length of the hermetically sealed portions 13 and 14 is 60 mm, and the outside diameter of the hermetically sealed portions 13 and 14 is 22 mm. The diameter of the tip surface of the anode 25 is 5 mm.

According to the arrangement shown in FIG. 1, several discharge lamps of the short arc type 10 are produced, wherein the distance L between the two electrodes in the axial direction is 5 mm, the nominal current is 100 A, the nominal voltage is 30 V, the nominal wattage is 3 kW, the filling pressure of the xenon gas is 2 MPa, and wherein the amount d of displacement of the cathode 20 with respect to the anode 25 is changed according to Table 1 described below. These lamps are called “discharge lamp group 2”. The arrangement of the respective discharge vessel 11 is identical to that from the discharge lamp group 1.

According to the arrangement shown in FIG. 1, several discharge lamps of the short arc type 10 are produced in which the distance L between the two electrodes in the axial direction is 7 mm, the nominal current is 150 A, the nominal voltage is 33 V, the nominal wattage is 5.0 kW, the filling pressure of the xenon gas is 2 MPa, and wherein the amount d of displacement of the cathode 20 with respect to the anode 25 is changed according to Table 1 described below. These lamps are called “discharge lamp group 3”. The arrangement of the respective discharge vessel 11 is identical to that of the discharge lamp group 1.

According to the arrangement shown in FIG. 1, several discharge lamps of the short arc type 10 are produced in which the distance L between the two electrodes in the axial direction is 3.5 mm, the nominal current is 65 A, the nominal voltage is 30 V, the nominal wattage is 2 kW, the filling pressure of the xenon gas is 3 MPa, and wherein the amount d of displacement of the cathode 20 with respect to the anode 25 is changed according to Table 1 described below. These lamps are called “discharge lamp group 4”. The arrangement of the respective discharge vessel 11 is identical to that of the discharge lamp group 1.

In the respective discharge lamp produced in this way, an illumination test is run and the position of the base region of the arc A on the tip surface of the anode 25 is observed. Table 1 shows the following results:

TABLE 1

| | | | | | Ratio of | |
|---|---|---|---|---|---|---|
| | 1) | Distance L | | Amount of | the amount | |
| | | between the | | displace- | d of dis- | Position of |
| | | two electrodes | | ment d | placement | the base |
| Dis- | 2) | Filling pres- | | (mm) of | to the dis- | region on |
| charge | | sure of the gas | | the cathode | tance L be- | the tip sur- |
| Lamp | 3) | Nominal watt- | | with respect | tween the two | face of |
| Group | | age | | to the anode | electrodes (%) | the anode |
| 1 | 1) | 4.0 | mm | 0.3 | 7.5 | x; anode |
| | | | | | | up |
| | 2) | 2 | MPa | 0.4 | 10 | o; anode |
| | | | | | | in middle |
| | 3) | 2.0 | kW | 0.6 | 15 | o; anode |
| | | | | | | in middle |
| | | | | 0.8 | 20 | x; anode |
| | | | | | | down |
| 2 | 1) | 5.0 | mm | 0.4 | 8 | x; anode |
| | | | | | | up |
| | 2) | 2 | MPa | 0.5 | 10 | o; anode |
| | | | | | | in middle |
| | 3) | 3 | kW | 0.75 | 15 | o; anode |
| | | | | | | in middle |
| | | | | 0.9 | 18 | x; anode |
| | | | | | | down |
| 3 | 1) | 7.0 | mm | 0.6 | 8.5 | x; anode |
| | | | | | | up |
| | 2) | 2 | Mpa | 0.7 | 10 | o; anode |
| | | | | | | in middle |
| | 3) | 5.0 | kW | 1.05 | 15 | o; anode |
| | | | | | | in middle |
| | | | | 1.2 | 17.1 | x; anode |
| | | | | | | down |
| 4 | 1) | 3.5 | mm | 0.3 | 8.6 | x; anode |
| | | | | | | up |
| | 2) | 3 | MPa | 0.35 | 10 | o; anode |
| | | | | | | in middle |
| | 3) | 2 | kW | 0.5 | 14.3 | o; anode |
| | | | | | | in middle |
| | | | | 0.7 | 20 | x; anode |
| | | | | | | down |

As shown in Table 1, it was confirmed that for the respective discharge lamp groups 1 to 4 in the discharge lamps of the invention in which the amount d of displacement of the cathode 20 relative to the anode 25 is 10 to 15% of the distance L between the two electrodes in the axial direction, the base region of the arc A is essentially the same size as the diameter of the tip surface of the anode 25 and that the arc A is confined by the entire area of the tip surface of the anode 25 (see FIG. 2).

Conversely, in the case in which the amount d of the displacement of the cathode 20 relative to the anode 25 is less than 10% of the distance L between the two electrodes in the axial direction, the base region of the arc A covers the tip surface of the anode 25 such that it is polarized on the upper position of the tip surface of the anode 25. In the case in which the distance d of displacement of the cathode 20 relative to the anode 25 is greater than 15% of the distance L between the two electrodes, the base region of the arc A covers the tip surface of the anode 25 such that it is polarized on the lower position of the tip surface of the anode 25. It was confirmed that in any case the base region of the arc A covers the tip surface of the anode 25 in a locally concentrated manner. In these discharge lamps, the anode 25 is deformed within a short time and the arc A could no longer be stably formed. As such, these lamps are therefore no longer usable.

By means of the discharge lamp of the short arc type of the invention, which emits light with high radiance and which is subjected to horizontal operation, the arc in the middle area on the tip surface of the anode is reliably held and stably formed. Therefore, a stable operating characteristic over a long period can be obtained without the anode being deformed or worn, unless only locally. It can therefore be used advantageously as the light source of a projection device (DLP cinema projector) in which, for example, DLP (digital light processing) technology is used.

Furthermore the arrangement of the base with a means for controlling the operating position in the hermetically sealed portion of the discharge vessel makes it possible to adjust the discharge lamp such that it has an operating position in which the cathode and the anode are located on top of one another so that the cathode is positioned shifted down relative to the anode.

What we claim is:

1. Discharge lamp of the short arc type comprising:
a discharge vessel;
a cathode having a tip area that is in the shape of a truncated cone and disposed in said discharge vessel; and
an anode with a tip area that is in the shape of a truncated cone and disposed in said discharge vessel opposite the cathode, the tip area of the anode being spaced from the tip area of the cathode in an axial direction by a gap distance;
wherein the discharge lamp is adapted to be operated in a position in which a center axis of the cathode and a center axis of the anode are each positioned horizontally;
wherein the discharge lamp has an operational nominal wattage of 0.5 kW to 5 kW;
wherein the discharge vessel contains xenon gas with a filling pressure at least equal to 1.5 MPa;
wherein the center axis of the cathode is displaced downward in a radial direction relative to the center axis of the anode by a distance which is 10% to 15% of the gap distance between the cathode and the anode in the axial direction.

2. Discharge lamp of the short arc type as claimed in claim 1, wherein the gap distance between anode and the cathode is at most 7.0 mm.

3. Discharge lamp of the short arc type as claimed in claim 2, wherein the gap distance between the anode and the cathode is from 3.0 to 5.0 mm.

4. Discharge lamp of the short arc type as claimed in claim 1, wherein an end-face tip area of the anode opposite the cathode has a diameter which is 0.8 to 1.2 times the gap distance between the cathode and the anode.

5. Discharge lamp of the short arc type as claimed in claim 1, wherein the filling pressure of the xenon is at least 2 MPa.

6. Discharge lamp of the short arc type as claimed in claim 1, wherein at least one end of the discharge vessel is provided with a base which has a means for controlling the operating position of the discharge lamp.

7. Discharge lamp of the short arc type as claimed in claim 6, wherein the base has a collar for at least partial accommodation in a lamp holder, wherein the collar is provided with a control surface which runs at a given angle to a plane containing the center axes of the cathode and anode, and wherein the lamp holder has an opposing surface on which the control surface comes to rest such that the discharge lamp is at a position at which the center axis of the cathode is located essentially vertically above the center axis of the anode during operation.
